(19) United States
(12) Patent Application Publication
(10) Pub. No.: US 2003/0027546 A1
(43) Pub. Date: Feb. 6, 2003

(54) Information transmission system, information sending/receiving system and information terminal

(75) Inventor: Koichi Kobayashi, Tachikawa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/134,466

(22) Filed: Apr. 30, 2002

(30) Foreign Application Priority Data
Jul. 31, 2001 (JP) 2001-232477

(51) Int. Cl. H04M 11/00

(52) U.S. Cl. 455/403; 455/41; 455/456; 455/414

(57) ABSTRACT

An information sending/receiving system performs bidirectional radio communication with an information terminal via a plurality of antennas provided at a plurality of radio relay points, respectively. When the information sending/receiving system has detected an information terminal capable of radio communication via the antennas, the information sending/receiving system performs transmission/reception of information with this information terminal.

### CROSS-REFERENCE TO RELATED APPLICATIONS

This application is based upon and claims the benefit of priority from the prior Japanese Patent Application No. 2001-232477, filed Jul. 31, 2001, the entire contents of which are incorporated herein by reference.

### BACKGROUND OF THE INVENTION

1. Field of the Invention

The present invention relates to an information transmission system for transmitting information by radio communication, and an information sending/receiving system and an information terminal, which are used in the information transmission system.

2. Description of the Related Art

In general, when information relating to a given location, such as information on available seats in a restaurant or information on an available area in a parking lot, is to be obtained from a moving vehicle, a mobile phone or a PHS (Personal handyphone System) in the vehicle is connected to an information provider via a public network (a mobile phone network or a PHS network). For example, a mobile phone is connected to an Internet service provider via a public network, and information published on a Web site can be obtained via the Internet.

A car navigation system equipped with a system, which can cooperate with a vehicle information and communication system (VICS), can obtain in real time traffic information relating to traffic jam, accidents, traffic restriction, parking, etc.

A mobile telephone or a PHS is connected to an information provider via a public network to obtain necessary information. Alternatively, information can be obtained by the VICS via beacons or FM multiplex broadcasting.

However, when information is obtained from an information provider via a public network, a communication cost is incurred each time connection to the information provider is established, and a cost is incurred to obtain information. The PHS is provided with an inter-sub-terminal communication mode (transceiver mode), which permits local communication without intervention of a public network. However, the same authentication number (ID code) must be used by a main terminal and a sub-terminal for communication. Thus, a PHS cannot be connected to a non-specified terminal at the other end, and necessary information cannot be obtained.

Moreover, when information is obtained by the VICS using beacons or FM multiplex broadcasting, no communication cost is incurred, but such information is unidirectionally provided by the system. Thus, desired information is not necessarily obtained.

### BRIEF SUMMARY OF THE INVENTION

The object of the present invention is to provide an information transmission system capable of transmitting information desired by a user, without incurring a cost for acquisition of information, and an information sending/receiving system and an information terminal, which are used in the information transmission system.

According to an aspect of the invention, there is provided an information transmission system having an information sending/receiving system which transmits information by radio communication, and an information terminal which acquires information from the information sending/receiving system by radio communication, the information sending/receiving system comprising: a first radio control module which executes bidirectional radio communication with the information terminal; an information terminal detection module which detects the information terminal capable of radio communication by the first radio control module; and an information transmission/reception unit which transmits and receives information by the first radio control module to and from the information terminal detected by the information terminal detection module, and the information terminal comprising: a second radio control module which executes bidirectional radio communication with the first radio control module; an information sending/receiving system detection module which detects the information sending/receiving system capable of radio communication by the second radio control module; an information setting unit which sets information to be desired; an information receiving module which receives information sent from the information sending/receiving system detected by the information sending/receiving system detection module; and an information output unit which outputs information set by the information setting unit, which corresponds to the information received by the information receiving module.

In the information transmission system, it is possible that radio communication is effected via antennas disposed at a plurality of radio relay points.

According to a second aspect of the invention, there is provided a information sending/receiving system which transmits information by radio communication, comprising: a radio control module which executes bidirectional radio communication with an information terminal; an information terminal detection module which detects the information terminal capable of radio communication by the radio control module; and an information transmission/reception unit which transmits and receives information by the radio control module to and from the information terminal detected by the information terminal detection module.

In the information sending/receiving system, it is possible that the information transmission/reception unit sends information requested by the information terminal detected by the information terminal detection module.

In the information sending/receiving system, it is possible that radio communication is effected via antennas disposed at a plurality of radio relay points.

In the information sending/receiving system, it is possible that the antennas are disposed at a plurality of radio relay points which are provided in succession, and the radio control module sets the antenna, which is located at the endmost radio relay point, in a constantly radio-communicable state, and the antennas, which are located at the radio relay points other than the endmost radio relay point, in a radio-communicable state where necessary.

The information sending/receiving system may further comprise a terminal position detection unit which detects the position of the information terminal, wherein the radio control module sets only that one of the antennas, which is other than the antenna provided at the endmost radio relay point and is close to the information terminal, in a radio-communicable state on the basis of the position of the information terminal detected by the terminal position detection unit.

In the information sending/receiving system, it is possible that the radio control module controls radio communication by Bluetooth.

According to a third aspect of the invention, there is provided an information terminal which acquires information by radio communication, comprising: a radio control module which executes bidirectional radio communication with an information sending/receiving system; an information sending/receiving system detection module which detects the information sending/receiving system capable of radio communication by the radio control module; an information setting unit which sets information to be desired; an information receiving module which receives information sent from the information sending/receiving system detected by the information sending/receiving system detection module; and an information output unit which outputs information set by the information setting unit, which corresponds to the information received by the information receiving module.

The information terminal may further comprise: an input unit which inputs information representing a response to the information output by the information output unit; and an information transmission unit which transmits the information, which has been by the input unit, to the information sending/receiving system detected by the information sending/receiving system detection module.

The information terminal may further comprise: a position measuring module which measures a current position; and a position information transmission unit which transmits position information indicative of the current position measured by the position measuring module to the information sending/receiving system detected by the information sending/receiving system detection module.

The information terminal may further comprise: a position measuring module which measures a current position; and a map output unit which outputs, on a map, the information received by the information receiving module along with information on the current position measured by the position measuring module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the system configuration of an information transmission system according to an embodiment of the invention;

FIG. 2 is a system block diagram showing a detailed structure of an information sending/receiving system 10;

FIG. 3 is a system block diagram showing a detailed structure of an information terminal 12 mounted in a vehicle;

FIG. 4 is a flow chart illustrating the operation of the information terminal 12 according to a first information acquisition method;

FIGS. 5A to 5D show examples of a screen image displayed on the information terminal 12;

FIGS. 6A and 6B show examples of the screen image displayed on the information terminal 12;

FIG. 7 show an example of the screen image displayed on the information terminal 12;

FIGS. 8A to 8D show examples of the screen image displayed on the information terminal 12;

FIG. 9 is a flow chart illustrating the operation of the information terminal 12 according to a second information acquisition method;

FIGS. 10A and 10B are flow charts illustrating the control of Bluetooth antennas 27a, 27b and 27c disposed at a plurality of radio relay points in the information sending/receiving system 10; and

FIGS. 11A to 11C illustrate the state in which an antenna 27 capable of radio communication is changed in accordance with movement of a moving body 14.

### DETAILED DESCRIPTION OF THE INVENTION

An embodiment of the present invention will now be described with reference to the accompanying drawings.

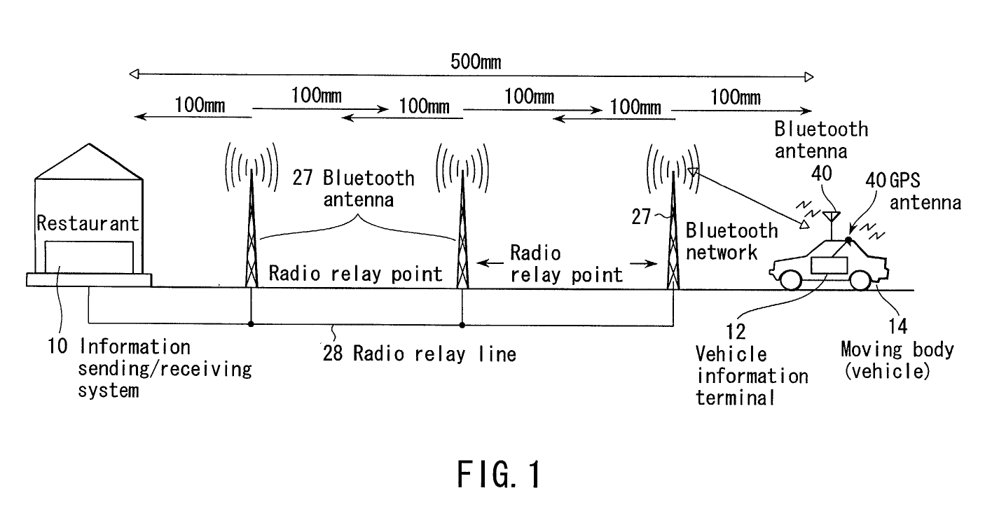

FIG. 1 is a block diagram showing the system configuration of an information transmission system according to the embodiment of the invention.

As is shown in FIG. 1, the information transmission system of this embodiment includes an information sending/receiving system 10 and an information terminal 12 equipped in a vehicle (hereinafter referred to as “vehicle information terminal 12”).

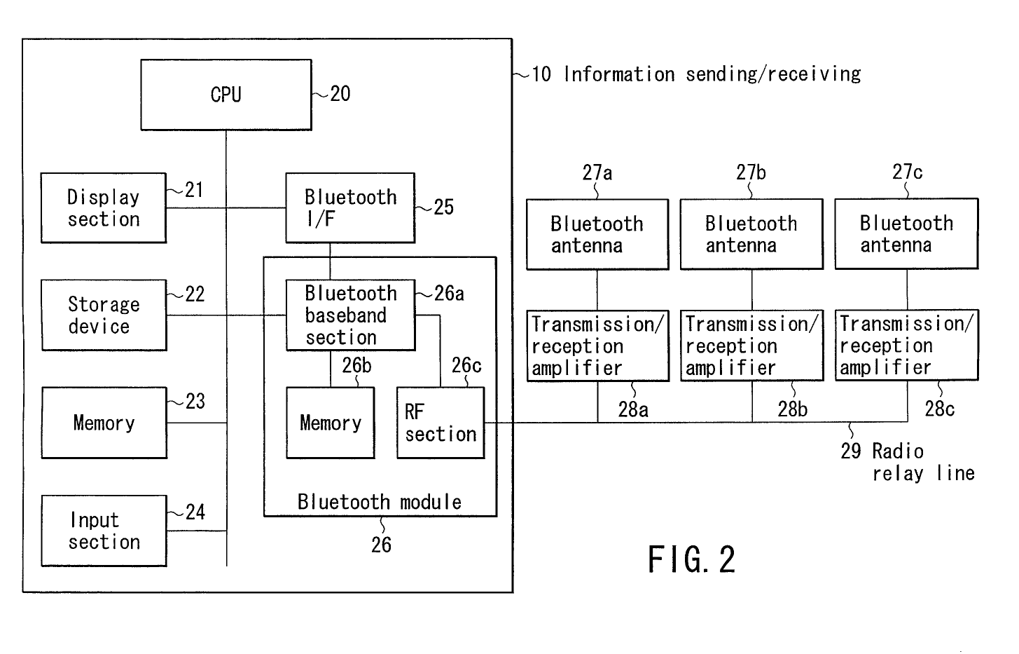

The information sending/receiving system 10 is provided with an information sending function for transmitting information by radio communication using a radio communication method, which does not incur a communication cost due to establishment of a communication link. In this embodiment, for example, radio communication is performed by Bluetooth radio communication standards. Alternatively, other radio communication standards may be used. The main body of the information sending/receiving system 10 is disposed, for example, in a restaurant that serves as an information provider. The information sending/receiving system 10 performs bidirectional communication with the vehicle information terminal 12 disposed in a moving body 14 such as an automobile via any one of Bluetooth antennas 27 provided at a plurality of radio relay points. The detailed structure of the information sending/receiving system 10 will be described later (FIG. 2).

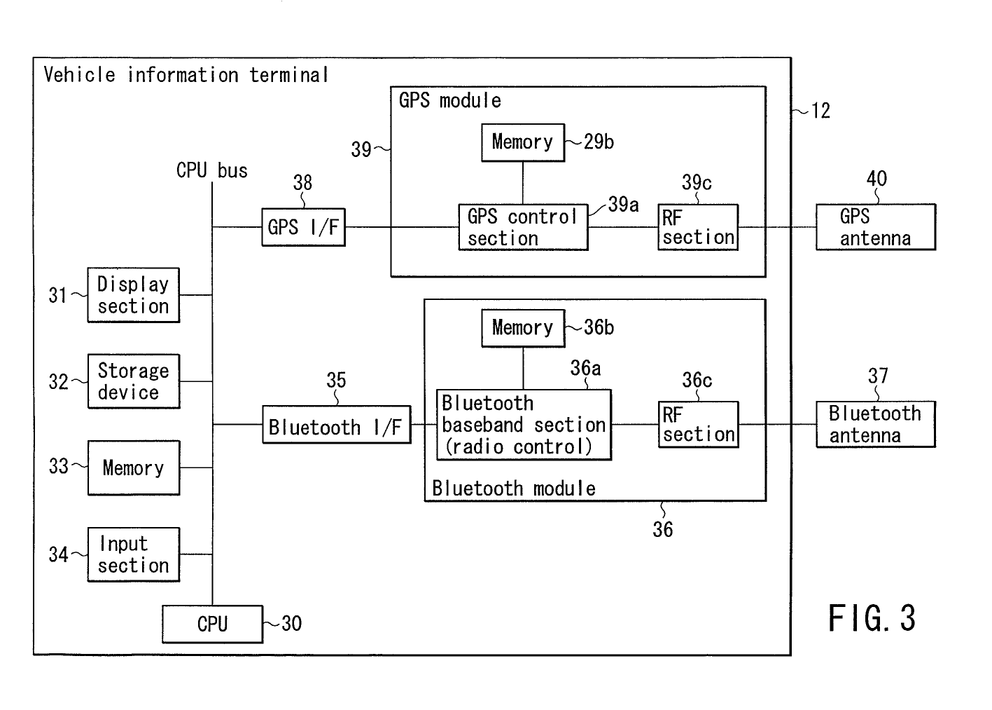

The vehicle information terminal 12 is provided with an information acquiring function for acquiring information by radio communication using a radio communication method, which does not incur a communication cost due to establishment of a communication link. In this embodiment, radio communication is performed by Bluetooth radio communication standards. In this embodiment, the vehicle information terminal 12 is constituted by, e.g. a car navigation system, and has a navigation function of displaying a current position measured by using a GPS (Global Positioning System). The detailed structure of the vehicle information terminal 12 will be described later (FIG. 3).

The information sending/receiving system 10 and vehicle information terminal 12 of the information transmission system are realized by computers, the operations of which are controlled by programs read from recording media such as CD-ROMs, DVDs or magnetic disks.

FIG. 2 is a system block diagram showing a detailed structure of the information sending/receiving system 10. As is shown in FIG. 2, the information sending/receiving system 10 comprises a CPU 20, a display section 21, a storage device 22, a memory 23, an input section 24, a Bluetooth interface (I/F) 25, a Bluetooth module 26, Bluetooth antennas 27 (27a, 27b, 27c) and transmission/reception amplifiers 28 (28a, 28b, 28c).

The CPU 20 controls the respective parts by executing programs stored in the memory 23. The functions realized by the CPU 20 include an information transmission/reception function and an antenna control function. In the information transmission/reception function, a vehicle information terminal 12, which is communicable via any one of the Bluetooth antennas 27 (27a, 27b, 27c), is detected, and information transmission/reception is effected with the detected vehicle information terminal 12. On the other hand, in the antenna control function, the Bluetooth antennas 27 and transmission/reception amplifiers 28 are selectively set in a radio-communication-enabled state.

In the display section 21, for example, an LCD displays a screen corresponding to programs executed by the CPU 20.

The storage device 22 comprises, for example, a hard disk drive, and stores programs and data. The storage device 22 stores, for example, a database registering information to be provided by radio communication to the vehicle information terminal 12 and information for managing the system. Specifically, the database registers various information relating to the restaurant equipped with the information sending/receiving system 10, such as menus, price lists, available seat information and available parking lot information. The content of the database is updated in real time. The database also registers information on the positions of the Bluetooth antennas 27 (27a, 27b, 27c).

The memory 23 comprises a ROM or a RAM, and stores programs and data executed by the CPU 20.

The input section 24 comprises a keyboard, a pointing device (a mouse or a tablet), etc. and enables a manager of the information sending/receiving system 10 to input various information.

The Bluetooth I/F 25 is an interface with the Bluetooth module 26.

The Bluetooth module 26 controls radio communication according to Bluetooth radio communication standards, and includes a Bluetooth baseband section 26a, a memory 26b and an RF section 26c. The Bluetooth baseband section 26a controls Bluetooth bidirectional radio communication as a whole. The Bluetooth baseband section 26a is controlled by programs stored in the memory 26b. The memory 26b stores programs that control the Bluetooth baseband section 26a. The RF section 26c transmits and receives radio-frequency waves with the vehicle information terminal 12 via the transmission/reception amplifiers 28 and Bluetooth antennas 27 under control of the Bluetooth baseband section 26a. The transmission/reception amplifiers 28 (28a, 28b, 28c) are connected to the RF section 26c via the Bluetooth antennas 27 and a radio relay line 29. Each transmission/reception amplifier 28 has a transmission signal amplifying function of amplifying a radio-frequency signal output from the RF section 26c and emitting it from the Bluetooth antenna 27, and a reception signal amplifying function of amplifying a radio-frequency signal received by the Bluetooth antenna 27 and inputting it to the RF section 26c. In accordance with an instruction from the CPU 20, the Bluetooth module 26 can selectively set the Bluetooth antennas 27 (27a, 27b, 27c) and transmission/reception amplifiers 28 (28a, 28b, 28c) in a radio-communication-enabled state. For example, the Bluetooth antenna 27c and transmission/reception amplifier 28c may be set in a radio-communication-enabled state, while the Bluetooth antennas 27a and 27b and transmission/reception amplifiers 28a and 28b are set in a radio-communication-disabled state. The Bluetooth module 26 can detect a radio-communication-enabled information terminal, etc. in accordance with the Bluetooth radio communication standards.

The Bluetooth antennas 27 (27a, 27b, 27c) include a plurality of Bluetooth antennas 27a, 27b and 27c provided at a plurality of radio relay points. The Bluetooth antennas 27 are connected to the RF section 26c of Bluetooth module 26 via the radio relay line 29 and transmission/reception amplifiers 28a, 28b and 28c. Accordingly, the Bluetooth antennas 27 transmit at the same timing the same radio waves according to the Bluetooth radio communication standards. In this embodiment, as shown in FIG. 1, the Bluetooth antennas 27a, 27b and 27c are disposed at successive radio relay points. The radio relay points are provided, for example, at shoulders of a road along which the moving body 14 (vehicle) runs. Normally, the reach of radio waves from the antenna is about 100 m at maximum according to the Bluetooth radio communication standards. The Bluetooth antennas 27 are arranged such that the ranges of reach of radio waves emitted from adjacent antennas partially overlap. By successively arranging the three Bluetooth antennas 27, as shown in FIG. 1, radio waves from the information sending/receiving system 10 can be made to reach locations, for example, at a distance of 500 m from the place (restaurant) of the information sending/receiving system 10.

In FIG. 1, the Bluetooth antennas 27 are linearly arranged. Alternatively, they may be arranged in a desired fashion in accordance with the range of information transmission. For the purpose of simple description, FIG. 1 shows three Bluetooth antennas 27a, 27b and 27c. Alternatively, two Bluetooth antennas 27, or four or more Bluetooth antennas 27 may be provided and connected by the radio relay line 29.

FIG. 3 is a system block diagram showing a detailed structure of the vehicle information terminal 12. As is shown in FIG. 3, the vehicle information terminal 12 comprises a CPU 30, a display section 31, a storage device 32, a memory 33, an input section 34, a Bluetooth interface (I/F) 35, a Bluetooth module 36, a Bluetooth antenna 37, a GPS interface (I/F) 38, a GPS module 39, and a GPS antenna 40.

The CPU 30 executes programs stored in the memory 33, thereby controlling the respective parts and realizing the respective functions. The functions realized by the CPU 30 include a function of a car navigation system using a GPS, and an information acquiring function for acquiring various information from the information sending/receiving system 10 using the Bluetooth module 36.

In the display unit 31, for example, an LCD displays a screen according to a program executed by the CPU 30. When the function of the car navigation system is performed by the vehicle information terminal 12, the display section 31 displays a map indicating a current position. On the other hand, when the information acquiring function is performed by the vehicle information terminal 12, the display section 31 displays a menu screen for designating information to be acquired, information acquired from the information sending/receiving system 10, etc.

The storage device 32 comprises an apparatus designed for storage media such as a hard disk, a CD-ROM and a DVD. The storage device 32 stores programs and data. The data stored in the storage device 32 includes map data for the navigation function, and menu screen data for the information acquiring function. The map data includes basic data on roads, names of places and addresses, and information relating to various buildings shown on the map, e.g. information on locations, addresses and names of buildings such as restaurants, amusement parks and sightseeing spots.

The memory 33 comprises a ROM or a RAM and stores programs and data executed or used by the CPU 30.

The input section 34 comprises a controller provided with buttons. The user of the vehicle information terminal 12 operates the input section 34 to input various information.

The Bluetooth I/F 35 is an interface with the Bluetooth module 36.

The Bluetooth module 36 controls radio communication according to Bluetooth radio communication standards. The Bluetooth module 36 includes a Bluetooth baseband section 36a, a memory 36b, and an RF section 36c. The Bluetooth baseband section 36a controls bidirectional radio communication as a whole. The Bluetooth baseband section 36a is controlled on the basis of programs stored in the memory 36b. The memory 36b stores the programs that control the Bluetooth baseband section 36a. Under control of the Bluetooth baseband section 36a, the RF section 36c transmits and receives radio-frequency waves via the Bluetooth antenna 37. The Bluetooth module 36 can detect a radio-communication-enabled system, etc. according to the Bluetooth radio communication standards.

The Bluetooth antenna 37 is connected to the RF section 36c and transmits and receives radio waves according to the Bluetooth radio communication standards.

The Bluetooth module 36 and Bluetooth antenna 37 may not be preinstalled in the vehicle information terminal 12. These may be additionally mounted as optional devices in the vehicle information terminal 12 constructed as a car navigation system.

The GPS I/F 38 is an interface with the GPS module 39.

The GPS module 39 controls the measurement of the current position by making use of a GPS. The GPS module 39 includes a memory 39a, a memory 39b and an RF section 39c. The GPS control section 39a controls the measurement of the current position and is controlled based on programs stored in the memory 39b. The memory 39b stores programs that control the GPS control section 39a. Under control of the GPS control section 39a, the RF section 39c receives radio waves from a GPS satellite via the GPS antenna 40.

The GPS antenna 40 is connected to the RF section 39a. The GPS antenna 40 receives radio waves from the GPS satellite and delivers them to the RF section 39c.

The operation of the system of the embodiment will now be described.

The information transmission system of the present embodiment can use one of first and second information acquiring methods. In the first information acquiring method, the vehicle information terminal 12 serves as a master for Bluetooth radio communication, and the information sending/receiving system 10 serves as a slave for Bluetooth radio communication. In the second information acquiring method, the information sending/receiving system 10 serves as a master, and the vehicle information terminal 12 as a slave.

In the first information acquiring method, the user presets in the vehicle information terminal 12 the content of information to be requested from the information sending/receiving system 10. When radio communication between the vehicle information terminal 12 and information sending/receiving system 10 has been enabled by an inquiry from the vehicle information terminal 12, the preset content of the information to be requested is sent to the information sending/receiving system 10.

In the second information acquiring method, the category of information (destination category) desired by the user is preset in the vehicle information terminal 12. When the vehicle information terminal 12 responds to an inquiry from the information sending/receiving system 10 to enable radio communication therebetween, the vehicle information terminal 12 receives information from the information sending/receiving system 10. If the received information agrees with the category of the preset information, a process corresponding to the information received from the information sending/receiving system 10 is carried out.

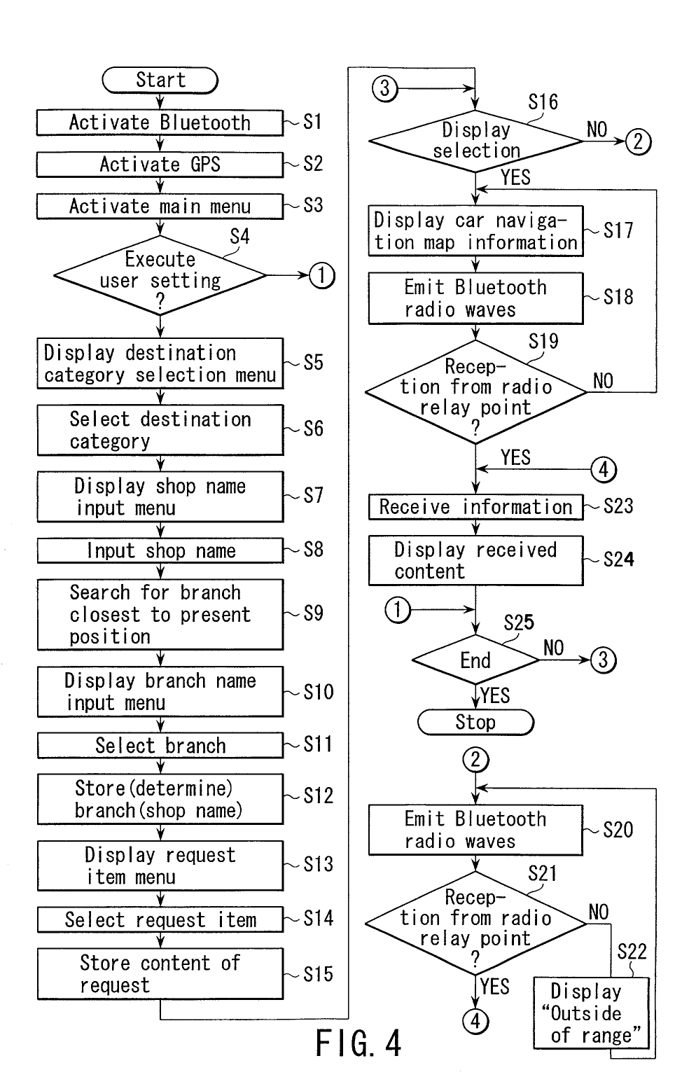

The operation of the system using the first information acquiring method will now be described with reference to a flow chart of FIG. 4 illustrating the operation of the vehicle information terminal 12.

The CPU 30 of the vehicle information terminal 12 activates the programs stored in the memory 33, which realize the information acquiring function and the navigation function, and then activates the Bluetooth module 26 and GPS module 39 (steps S1 and S2).

In order to set the content of information to be requested from the information sending/receiving system 10, the CPU 30 reads out menu screen data of a main menu from the storage device 32 and causes the display section 31 to display the main menu based on the menu screen data (step S3).

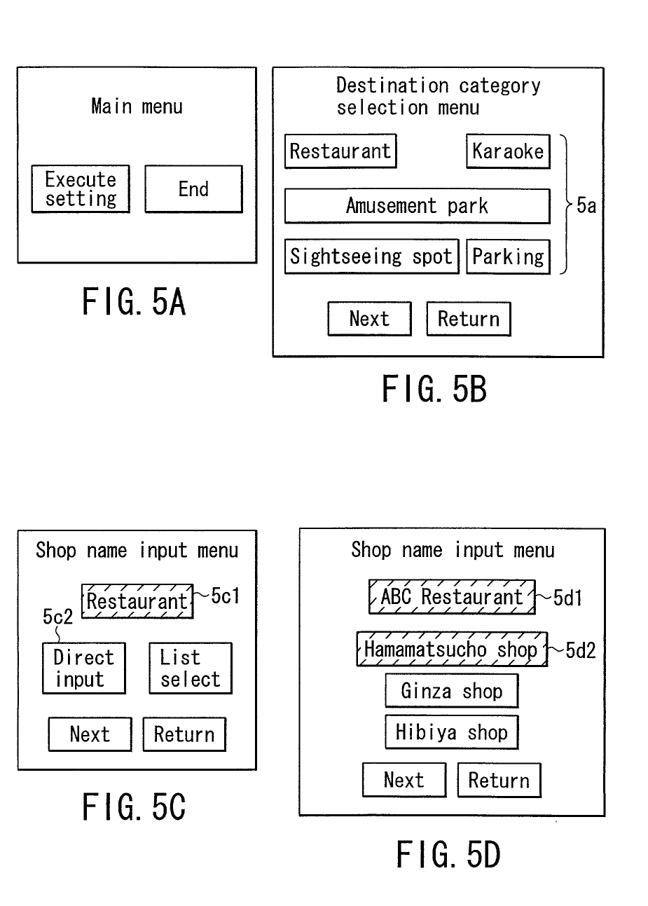

FIG. 5A shows an example of the screen of the main menu. The main menu is used to determine whether the content of information to be requested from the information sending/receiving system 10 is set or not, and the main menu shows items “EXECUTE SETTING” and “END”.

If an instruction to select item “EXECUTE SETTING” on the main menu is input from the input section 34 (step S4), the CPU 30 reads out menu screen data on a destination category selection menu from the storage device 32 and causes the display 31 to display the destination category selection menu based on the readout menu screen data (step S5).

FIG. 5B shows an example of the screen displaying the destination category selection menu. The destination category selection menu is used to designate one of destination categories 5a, “RESTAURANT”, “KARAOKE”, “AMUSEMENT PARK”, “SIGHTSEEING SPOT”, and “PARKING”.

If an instruction to select one of the categories on the destination category selection menu is input through the input section 34 (step S6), the CPU 30 reads out menu screen data on a destination name input menu from the storage device 32 and causes the display section 31 to display the destination name input menu based on the menu screen data (step S7). For example, if item “RESTAURANT” is selected on the destination category selection menu, the display section 31 displays a shop name input menu, as shown in FIG. 5C, for inputting the name of a restaurant that is a destination. The shop name input menu provides an item “DIRECT INPUT” for direct input of the shop name by the user, and an item “LIST SELECTION” for selection of the shop name of a prepared list.

For example, if the item “DIRECT INPUT” 5c2 on the shop name input menu is selected, the CPU 30 causes the display section 31 to display the next menu of the shop name input menu. This next menu, as shown in FIG. 5D, provides an input box 5d1 for direct input of a shop name.

If a shop name “ABC RESTAURANT” is input to the input box 5d1 through the input section 34 (step S8), as shown in FIG. 5D, the CPU 30 searches for data relating to buildings shown on a map included in map data for the navigation function, on the basis of the input destination category “RESTAURANT” and shop name “ABC RESTAURANT” (step S9). The CPU 30 also searches for shop names near the present position, which are acquired from the GPS module 39, and displays a branch input menu, as shown in FIG. 5D (step S10). In the example of FIG. 5D, branches “HAMAMATSUCHO SHOP”, “GINZA SHOP” and “HIBIYA SHOP” of “ABC RESTAURANT” have been searched for, and displayed as items on the branch input menu. Assume that “HAMAMATSUCHO SHOP” was selected from the branch names displayed on the branch input menu (step S11). The CPU 30 stores in the memory 33 the information relating to the destination, such as a branch name, designated by the user (step S12).

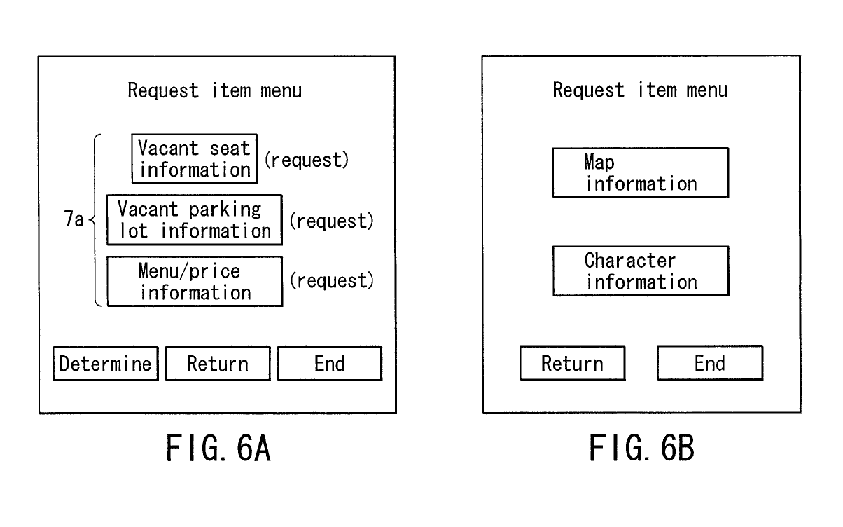

Subsequently, the CPU 30 causes the display section 31 to display a request item menu for selection of a request item indicating the content of information to be acquired from the information sending/receiving system 10 at the destination (step S13). FIG. 6A shows an example of the request item menu. The request item menu provides items 7a, “VACANT SEAT INFORMATION”, “VACANT PARKING LOT INFORMATION”, and “MENU/PRICE INFORMATION”, which indicate information capable of being requested from the restaurant. The user can select a desired item from the request item menu. Assume that all the three items have been selected as request items (step S14). The CPU 30 stores in the memory 33 the content of the request items selected from the request item menu (step S15).

Then, the CPU 30 causes the display section 31 of vehicle information terminal 12 to display a display selection menu for selection of display of map information or display of character information. FIG. 6B shows an example of the display selection menu. The display selection menu provides an item “MAP INFORMATION” for instructing map information display and an item “CHARACTER INFORMATION” for instructing character information display.

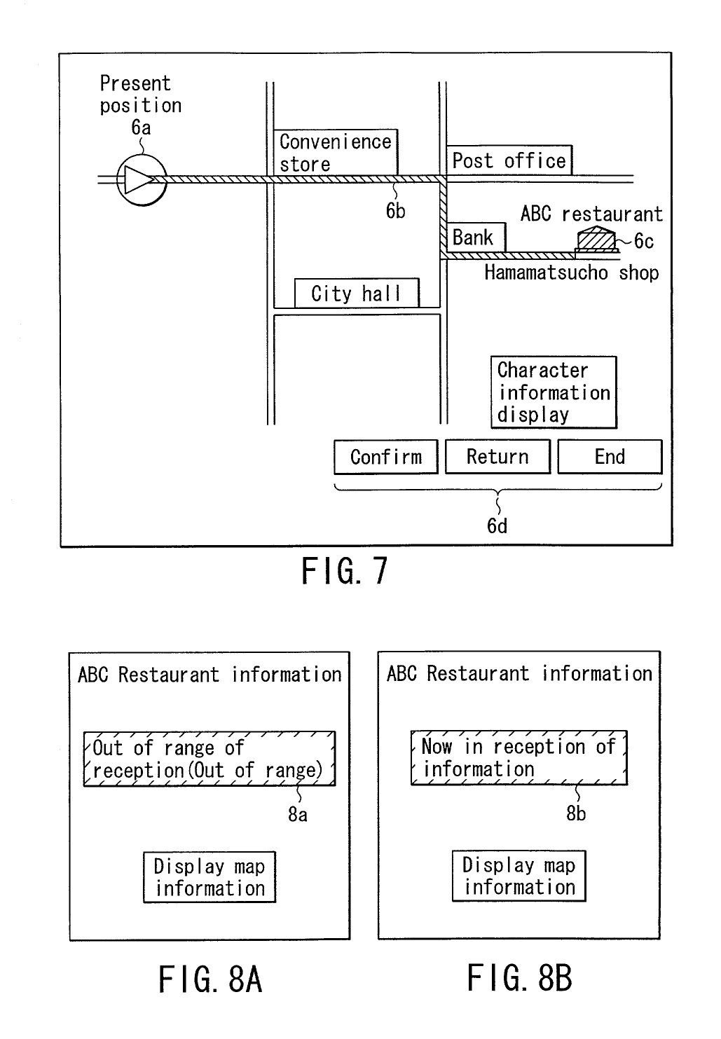

If item “MAP INFORMATION” is selected through the input section 34 (step S16), the CPU 30 causes the display section 31 to display a current position and a destination on the map information by the car navigation function using the GPS. At the same time, the CPU 30 searches for a route to the selected destination and causes the display section 31 to display the route on the map (step S17). FIG. 7 shows an example of a map indicating a present position 6a, a location 6c of the HAMAMATSUCHO SHOP of “ABC RESTAURANT” that is the destination, and a route 6b between the present position 6a and the destination.

In parallel with the display of the map information, the CPU 30 controls the Bluetooth module 36 to emit radio waves from the Bluetooth antenna 37 for inquiry broadcast to search for the information sending/receiving system 10 (step S18), and the CPU 30 determines whether radio waves indicating a response from the information sending/receiving system 10 have been received from the Bluetooth antenna 27 disposed at a radio relay point on the shoulder of the road, for instance (step S19).

The information sending/receiving system 10 performs an inquiry scan for receiving an inquiry from the vehicle information terminal 12. When the information sending/receiving system 10 has received the inquiry broadcast radio waves from the vehicle information terminal 12 via the Bluetooth antenna 27, it emits radio waves of an inquiry response.

If no radio waves of an inquiry response are emitted from the Bluetooth antenna 27 disposed at the radio relay point, that is, if no radio waves of an inquiry response are received, the CPU 30 of vehicle information terminal 12 continues the display of the map information.

On the other hand, when item “CHARACTER INFORMATION” on the display selection menu has been selected (step S16), the CPU 30 of vehicle information terminal 12 controls the Bluetooth module 36 to emit inquiry broadcast radio waves from the Bluetooth antenna 37 (step S20) and waits for reception of radio waves of an inquiry response.

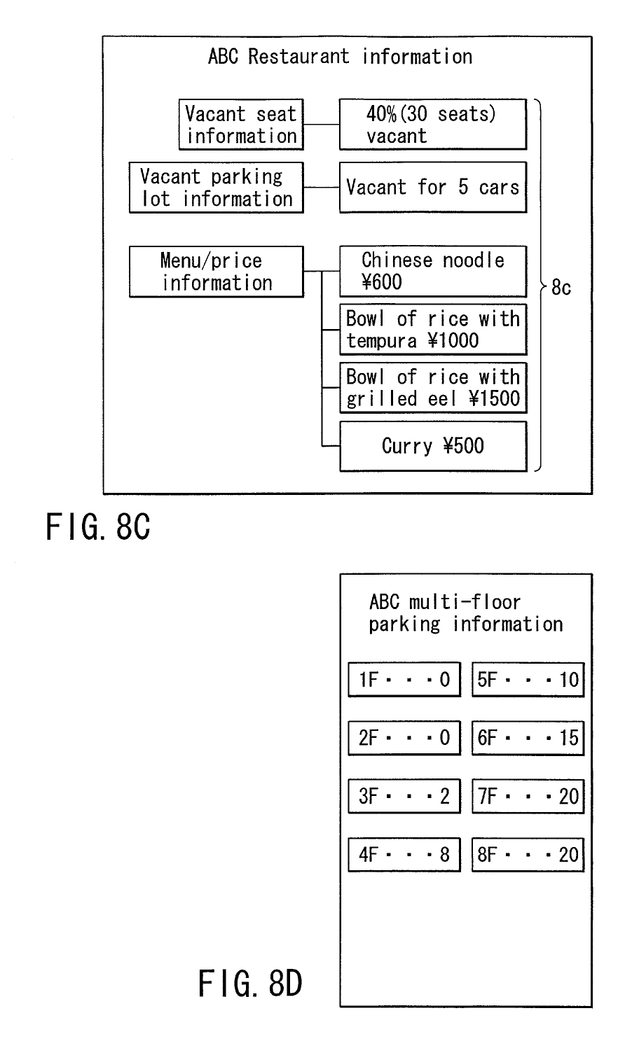

If no radio waves of an inquiry response are emitted from the Bluetooth antenna 27 disposed at the radio relay point, that is, if no radio waves of an inquiry response are received, the CPU 30 of vehicle information terminal 12 causes the display section 31 to display a screen, as shown in FIG. 8A, to inform the user that the present position is outside the reception range (OUTSIDE OF RANGE) (step S22). This screen provides an item “MAP INFORMATION DISPLAY” for instructing change of display to the map information display. If this item is selected, the CPU 30 changes the screen to the map display using the navigation function.

If the Bluetooth module 36 of vehicle information terminal 12 receives radio waves of an inquiry response to the inquiry broadcast radio waves via the Bluetooth antenna 37 (steps S19 and S21), the Bluetooth module 36 is connected to the Bluetooth module 26 of information sending/receiving system 10. The CPU 30 sends the content of a request item stored in the memory 33 and a request for acquisition of information to the information sending/receiving system 10 connected via the Bluetooth module 36. The information sending/receiving system 10 obtains from the database in the storage device 22 the information corresponding to the request item from the vehicle information terminal 12 and returns it to the vehicle information terminal 12 via the Bluetooth module 26.

If the vehicle information terminal 12 receives the information relating to the request item selected from the request item menu from the information sending/receiving system 10 (step S23), the display 31 displays a screen indicating the current state of reception, as shown in FIG. 8B. If the reception is completed, the display 31 displays the received content (step S24). FIG. 8C shows a screen displayed on the display section 31, which indicates information 8c about “ABC RESTAURANT” received from the information sending/receiving system 10, i.e. vacant seat information, vacant parking lot information and menu/price information. As regards the vacant parking lot information, if observation from the outside does not permit easy recognition, as in the case of a multi-floor parking lot, the display section 31 may display information, as shown in FIG. 8D, which is received from the information sending/receiving system 10 and indicates the number of cars capable of being parked in respective floors of the parking lot.

If the information acquiring function is continued after the acquisition of information from the information sending/receiving system 10, the CPU 30 goes to a process of displaying the display selection menu for selection of the screen display (step S16) and executes the same process as described above.

If the finish of the information acquiring function is instructed or if the moving body 14 is stopped and power supply is halted, the CPU 30 finishes the process (step S25).

In the first information acquiring method, the vehicle information terminal 12 is utilized. Thus, in parallel with the route display on the map to the destination by the navigation function, it is possible to acquire information item selected from the request item menu from the information sending/receiving system 10 installed at the destination (“ABC RESTAURANT”) via radio communication according to Bluetooth radio communication standards. In short, no communication cost is incurred since direct radio communication is performed between the information sending/receiving system 10 and vehicle information terminal 12.

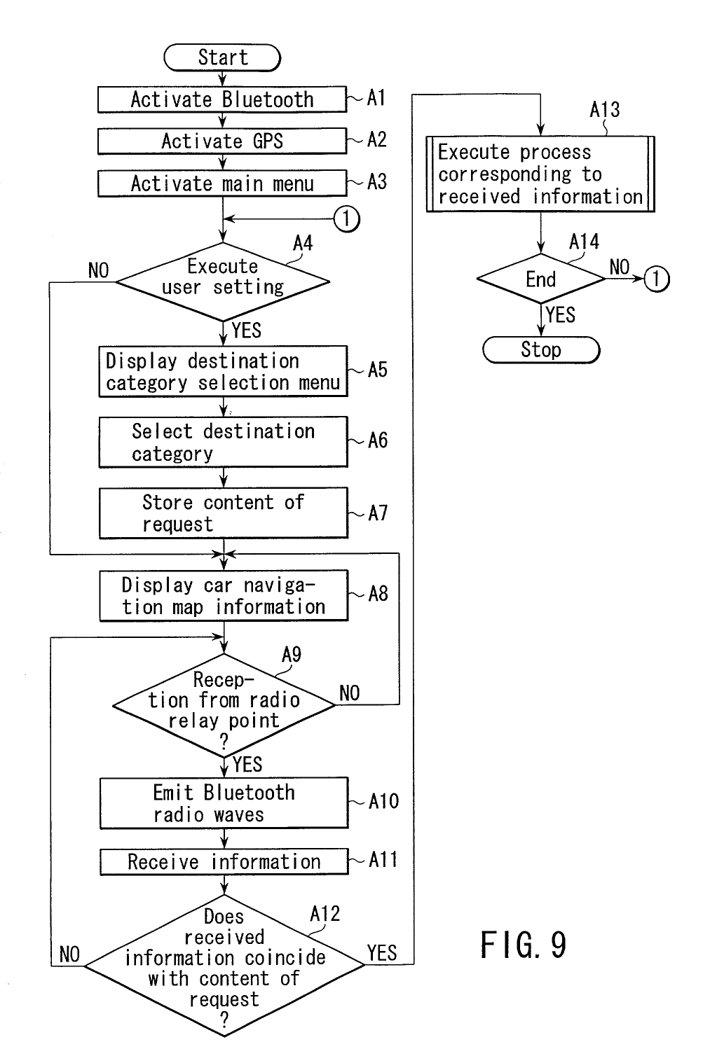

The operation of the system using the second information acquiring method will now be described with reference to a flow chart of FIG. 9 illustrating the operation of the vehicle information terminal 12.

The CPU 30 of the vehicle information terminal 12 activates the programs stored in the memory 33, which realize the information acquiring function and the navigation function, and then activates the Bluetooth module 26 and GPS module 39 (steps A1 and A2).

The CPU 30 reads out menu screen data of a main menu from the storage device 32 and causes the display section 31 to display the main menu based on the menu screen data (step A3). Assume that the main menu is the same as that shown in FIG. 5A, which was described in connection with the first information acquiring method.

If an instruction to select item “EXECUTE SETTING” on the main menu is input from the input section 34 (step A4), the CPU 30 reads out menu screen data on a destination category selection menu from the storage device 32 and causes the display 31 to display the destination category selection menu based on the read-out menu screen data (step A5). Assume that the destination category selection menu is the same as that shown in FIG. 5B, which was described in connection with the first information acquiring method.

If an instruction to select one of the categories on the destination category selection menu is input through the input section 34 (step A6), the CPU 30 stores in the memory 33 the content of the destination category selected from the destination category selection menu (step A7).

The CPU 30 causes the display section 31 to display a current position on the map information by the car navigation function using the GPS (step A7). The CPU 30 obtains through the GPS module 39 the position information varying in accordance with the movement of the moving body 14 using the car navigation function, and updates the display area of the map and the current position based on the position information.

In parallel with the map display using the car navigation function, the CPU 30 performs an inquiry scan for receiving radio waves from the information sending/receiving system 10 via the Bluetooth antenna 37 (step A9). On the other hand, the information sending/receiving system 10 emits radio waves for an inquiry broadcast to search for the vehicle information terminal 12 mounted in the moving body 14 (step A9).

When the Bluetooth module 36 of vehicle information terminal 12 has received the inquiry broadcast radio waves from the information sending/receiving system 10, it emits radio waves of an inquiry response (step A10).

If the Bluetooth module 36 of vehicle information terminal 12 emits the inquiry response radio waves, it establishes connection with the Bluetooth module 26 of information sending/receiving system 10. The CPU 30 requests the content of information provided by the information sending/receiving system 10, i.e. the information indicative of the destination category, from the information sending/receiving system 10 connected via the Bluetooth module 36. The information sending/receiving system 10 responds to the request from the vehicle information terminal 12 and informs the vehicle information terminal 12 that the information sending/receiving system 10 provides the information indicative of the destination category, e.g. information relating to the restaurant.

Upon receiving the information of the destination category from the information sending/receiving system 10, the CPU 30 of vehicle information terminal 12 determines whether this information agrees with the information of the destination category selected by the user and stored in the memory 33 (step A12). If the destination category information stored in the memory 33 does not coincide with the information received from information sending/receiving system 10, the vehicle information terminal 12 determines that it is connected to the information sending/receiving system 10 that does not provide the information desired by the user and finishes the communication with the information sending/receiving system 10.

On the other hand, if the destination category information stored in the memory 33 coincides with the information received from information sending/receiving system 10 (step A12), the vehicle information terminal 12 determines that it has been connected to the information sending/receiving system 10 that provides the information desired by the user and sends a request for transmission of information relating to the destination category to the information sending/receiving system 10.

For example, in the case where “RESTAURANT” is selected as the destination category in the vehicle information terminal 12, when the vehicle information terminal 12 is connected to the information sending/receiving system 10 disposed in a restaurant that provides the information relating to the restaurant, the vehicle information terminal 12 acquires the information from the information sending/receiving system 10. When the vehicle information terminal 12 is connected to the information sending/receiving system 10 disposed at a sightseeing spot that provides the information relating to the sightseeing spot, the vehicle information terminal 12 finishes the communication with the information sending/receiving system 10.

In the above description, when the information sending/receiving system 10 is connected to the vehicle information terminal 12, the vehicle information terminal 12 sends the request for transmission of information to the information sending/receiving system 10. Alternatively, the information sending/receiving system 10 may transmit information to the vehicle information terminal 12 without receiving the information transmission request from the vehicle information terminal 12.

Subsequently, the vehicle information terminal 12 executes a process in accordance with the information received from the information sending/receiving system 10 (step A13).

For example, in the first information acquiring method, the menu screen data for displaying the shop name input menu, branch name input menu and request item menu is prepared in advance in the vehicle information terminal 12. However, in the second information acquiring method, the menu screen data is acquired from the information sending/receiving system 10. The vehicle information terminal 12 displays the menu screen corresponding to the menu screen data acquired from the information sending/receiving system 10, and sends the user's instruction on the selection from the displayed menu to the information sending/receiving system 10. In accordance with the content of the instruction from the vehicle information terminal 12, the information sending/receiving system 10 sends the next menu screen data, or searches the database for information to be sent to the vehicle information terminal 12 and provides it to the vehicle information terminal 12.

In this way, the vehicle information terminal 12 performs the process in accordance with the information received from the information sending/receiving system 10. Thus, there is no need to provide the information acquiring function of the vehicle information terminal 12 with detailed process routines for acquiring various information. Moreover, when the information to be provided by the information sending/receiving system 10 to the vehicle information terminal 12 is to be changed, it should suffice if change is made in the information sending/receiving system 10 alone, for example, if the menu screen data provided by the 10 information sending/receiving system 10 is changed. In short, the information sending/receiving system 10 does not depend on the vehicle information terminal 12.

If the information acquiring function is continued after the acquisition of information from the vehicle information terminal 12, the CPU 30 goes to a process of displaying the display selection menu for selection of the screen display (step A4) and executes the same process as described above.

If the finish of the information acquiring function is instructed or if the moving body 14 is stopped and power supply is halted, the CPU 30 finishes the process (step A14).

In the second information acquiring method, like the first information acquiring method, no communication cost is incurred since direct radio communication is performed between the information sending/receiving system 10 and vehicle information terminal 12. Furthermore, if the destination category is selected in advance, information can be obtained from a certain information sending/receiving system 10 corresponding to the destination category. Besides, even if the vehicle information terminal 12 is connected to the information sending/receiving system 10 that does not corresponds to the destination category, information acquired from this information sending/receiving system 10 is not displayed and the radio communication with the information sending/receiving system 10 is stopped. Thus, the user is not frustrated.

In the above description, in the first information acquiring method, the vehicle information terminal 12 serves as a master for Bluetooth radio communication, and the information sending/receiving system 10 serves as a slave for Bluetooth radio communication. In the second information acquiring method, the information sending/receiving system 10 serves as a master, and the vehicle information terminal 12 as a slave. Alternatively, after the information sending/receiving system 10 and vehicle information terminal 12 are connected, master-slave switch may be effected according to Bluetooth communication standards, thereby to switch the master and slave.

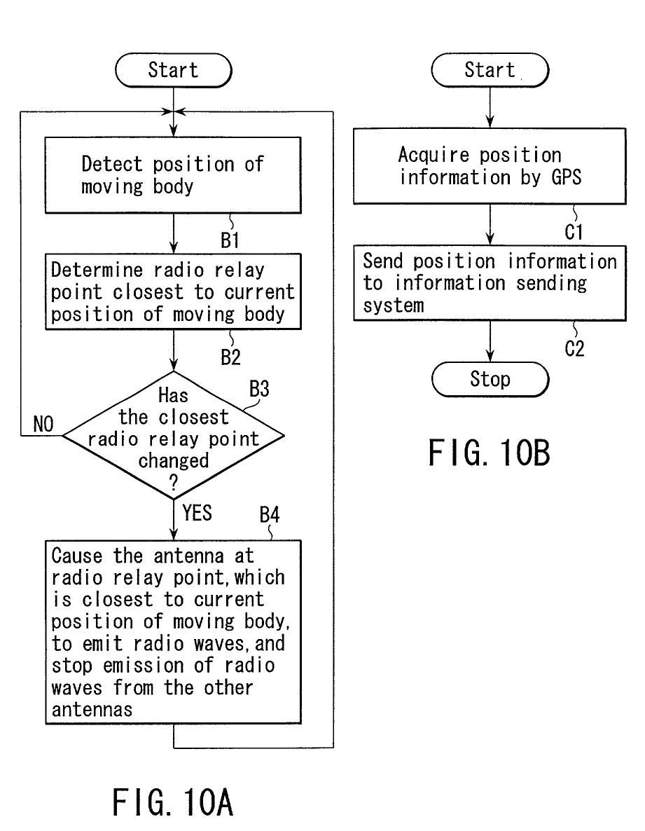

A description will now be given of the control of the Bluetooth antennas 27a, 27b and 27c disposed at a plurality of radio relay points in the information sending/receiving system 10. FIG. 10A is a flow chart illustrating the operation of the information sending/receiving system 10. FIG. 10B is a flow chart illustrating the operation of the vehicle information terminal 12.

The vehicle information terminal 12 always detects position information indicative of the present position by means of the GPS module 39 (step C1). The vehicle information terminal 12 sends to the information sending/receiving system 10 the position information detected by the GPS module 39 in a periodic manner or when some information is sent to the information sending/receiving system 10 (step C2).

The information sending/receiving system 10 receives the position information from the vehicle information terminal 12 and detects the position of the moving body 14 (vehicle information terminal 12) on the basis of the position information (step B1).

The information sending/receiving system 10 refers to the information indicative of the positions where the respective relay points are provided, which information is registered in the database constructed in the storage device 22, and determines the radio relay point which is closest to the current position of the moving body 14 (step B2). If the radio relay point closest to the current position of the moving body 14 has changed, the information sending/receiving system 10 causes the Bluetooth antenna 27 of the radio relay point, which is closest to the current position of the moving body 14, to emit radio waves. At the same time, the information sending/receiving system 10 stops emission of radio waves from the other Bluetooth antennas 27 (step B4). In other words, in accordance with the movement of the moving body 14, only the Bluetooth antenna 27 to be used for radio communication between the vehicle information terminal 12 and information sending/receiving system 10 is made effective.

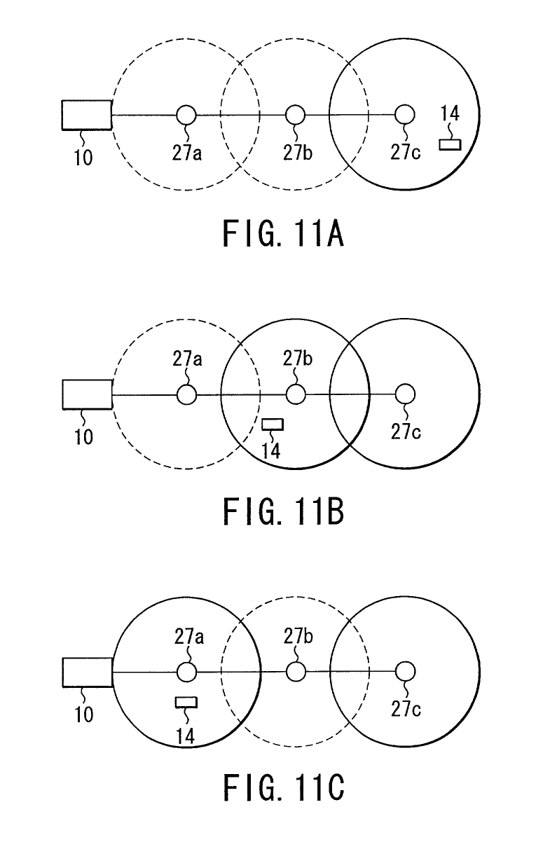

FIG. 11A to FIG. 11C illustrate how the Bluetooth antenna 27 capable of radio communication is changed in accordance with the movement of the moving body 14. In FIGS. 11A to 11C, circles associated with the respective Bluetooth antennas 27a, 27b and 27c indicate receivable ranges of radio waves sent from the antennas. The circles in solid lines indicate that the Bluetooth antennas associated with these circles are cable of radio communication. The circles in broken lines indicate that the Bluetooth antennas associated with these circles are incapable of radio communication.

In the initial state, as shown in FIG. 11A, only the Bluetooth antenna 27c, which is the endmost one of the successively arranged Bluetooth antennas 27, is in the radio-communicable state. When the moving body 14 has entered the range in which it can receive radio waves emitted from the Bluetooth antenna 27c, radio communication is enabled between the information sending/receiving system 10 and vehicle information terminal 12.

Then, with the movement of the moving body 14, as shown in FIG. 11B, the Bluetooth antenna 27b has become the closest one to the moving body 14. At this time, the information sending/receiving system 10 enables the Bluetooth antenna 27b to effect radio communication.

With further movement of the moving body 14, the Bluetooth antenna 27a has become the closest one to the moving body 14. At this time, as shown in FIG. 11C, the information sending/receiving system 10 enables the Bluetooth antenna 27a to effect radio communication and disables the Bluetooth antenna 27b to emit radio waves.

In this way, only the Bluetooth antenna 27 used for radio communication with the vehicle information terminal 12 is set in the radio-communicable state, thereby saving power consumption by the other Bluetooth antennas 27 that are not used for radio communication. Moreover, since radio waves are emitted from only the necessary Bluetooth antenna 27, emission of unnecessary radio waves is stopped to prevent an adverse effect such as radio interference.

In the control of Bluetooth antennas 27 described with reference to FIGS. 10A and 10B and 11A-11C, the Bluetooth antenna 27c, which is located at the endmost one of the successive radio relay points, is always set in the radio-communicable state. The reason is that information is provided to the vehicle information terminal 12 which is present far from the restaurant equipped with the information sending/receiving system 10, thereby to guide the moving body 14 (or a customer) with vehicle information terminal 12 within the wide area to the restaurant.

Depending on the arrangement of the Bluetooth antennas 27, the moving body 14 does not necessarily first receive radio waves emitted from the Bluetooth antenna 27c located at the endmost radio relay point. Thus, a specified one of the Bluetooth antennas 27 (e.g. Bluetooth antenna 27b), which is located at a radio relay point other than the endmost one, may always be set in the radio-communicable state.

As has been described above, the information sending/receiving system 10 can execute a control to selectively set the Bluetooth antenna 27 in the radio-communicable state. The information sending/receiving system 10 can flexibly determine the Bluetooth antenna 27 that is capable of radio communication, on the basis of the arrangement of radio relay points where the Bluetooth antennas 27 are disposed, the number of Bluetooth antennas 27, and the relationship between the arrangement of Bluetooth antennas 27 and the direction of movement of the moving body 14.

In the above description, position information is sent from the vehicle information terminal 12 to information sending/receiving system 10. Alternatively, the position of the vehicle information terminal 12 (moving body 14) may be determined by other methods. For example, the information sending/receiving system 10 may be provided with a function of measuring the intensity of radio waves sent from the vehicle information terminal 12 and received by the Bluetooth antennas 27a, 27b and 27c. Based on the intensity of radio waves received by the Bluetooth antennas 27a, 27b and 27c and the positions of these Bluetooth antennas, the position of the vehicle information terminal 12 can be detected. In this case, it is desirable that the Bluetooth antennas 27a, 27b and 27c should not be arranged linearly, and that the radio waves from the vehicle information terminal 12 should be received by three or more Bluetooth antennas 27.

In the above description, for the purpose of simplicity, it is assumed that information is sent from the information sending/receiving system 10 to one vehicle information terminal 12. Alternatively, information may be sent to a plurality of vehicle information terminals 12 at the same time. According to the Bluetooth communication standards, one master can radio-communicate with seven slaves. If the information sending/receiving system 10 is used as a master, it can simultaneously perform the abovedescribed process in parallel for seven vehicle information terminals 12.

Additionally, if the information sending/receiving system 10 is equipped with a plurality of Bluetooth modules 26 and is used as multiple master devices, the information sending/receiving system 10 can simultaneously perform the above-described process in parallel for eight or more vehicle information terminals 12. For instance, if the information sending/receiving system 10 is equipped with two Bluetooth modules 26, it can simultaneously send information to 14 vehicle information terminals 12. In this case, the Bluetooth modules 26 are provided with radio relay lines, respectively, and connected to Bluetooth antennas 27. These Bluetooth antennas 27 may be shared by the Bluetooth modules 26.

If the information sending/receiving system 10 is constructed to function as multiple master devices, as mentioned above, information can be sent to more vehicle information terminals 12. In a case where information is sent from the information sending/receiving system 10 to guide customers to a restaurant, etc., if information is sent in parallel to more vehicle information terminals 12, a more customer attraction effect is obtained.

As has been described above, since radio communication according to Bluetooth communication standards is performed between the information sending/receiving system 10 and vehicle information terminal 12, no communication cost is incurred. In addition, since bidirectional radio communication is performed, real-time information exchange can be performed. Specifically, the content of desired information is sent from the vehicle information terminal 12 to information sending/receiving system 10, and the information sending/receiving system 10 sends necessary information to vehicle information terminal 12, or the vehicle information terminal 12 sends information (e.g. a menu order in a restaurant) to the information sending/receiving system 10. Furthermore, since Bluetooth is worldwide radio communication standards, there is no restrictions on the countries where the information sending/receiving system 10 and vehicle information terminal 12 are used or where the information sending/receiving system 10 and vehicle information terminal 12 are manufactured.

The above description is directed to the vehicle information terminal 12. Alternatively, an information terminal having the same functions as the vehicle information terminal 12 can be realized by a PDA (Personal Digital Assistance) that has widely been used in these years as a personal portable information terminal. For example, this is realized by a combination of a PDA, a GPS module 39, a GPS antenna 40, a Bluetooth module 36, and a Bluetooth antenna 37. The information terminal constructed by using the PDA can be used by a user who moves on foot.

The method according to the above-described embodiment can be provided to various apparatuses in the form of computer-executable programs stored in a recording medium such as a magnetic disk (a flexible disk, a hard disk, etc.), an optical disk (a CD-ROM, a DVD, etc.), or a semiconductor memory. This method can be provided to various apparatuses via communication media. A computer that realizes each of the information sending/receiving system and information terminal reads in programs stored in a recording medium, or receives the programs via communication media. The operations of the computer are controlled by the programs, thus performing the above-described process.

The present invention is not limited to the above-described embodiment. Various modifications can be made in practice without departing from the spirit of the invention. The embodiment includes inventions in various stages, and various inventions can be derived from desired combinations of structural elements disclosed herein. For example, if an advantageous effect can be obtained even if some structural elements are omitted from all the structural elements disclosed in the embodiment, the structure without such structural elements can be derived as an invention.

As has been described above, according to the present invention, information desired by the user can be transmitted without incurring a cost for information acquisition.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information transmission system having an information sending/receiving system which transmits information by radio communication, and an information terminal which acquires information from the information sending/receiving system by radio communication,
the information sending/receiving system comprising:
a first radio control module which executes bidirectional radio communication with the information terminal;
an information terminal detection module which detects the information terminal capable of radio communication by the first radio control module; and
an information transmission/reception unit which transmits and receives information by the first radio control module to and from the information terminal detected by the information terminal detection module, and
the information terminal comprising:
a second radio control module which executes bidirectional radio communication with the first radio control module;
an information sending/receiving system detection module which detects the information sending/receiving system capable of radio communication by the second radio control module;
an information setting unit which sets information to be desired;
an information receiving module which receives information sent from the information sending/receiving system detected by the information sending/receiving system detection module; and
an information output unit which outputs information set by the information setting unit, which corresponds to the information received by the information receiving module.

2. An information transmission system according to claim 1, wherein radio communication is effected via antennas disposed at a plurality of radio relay points.

3. An information sending/receiving system which transmits information by radio communication, comprising:
a radio control module which executes bidirectional radio communication with an information terminal;
an information terminal detection module which detects the information terminal capable of radio communication by the radio control module; and
an information transmission/reception unit which transmits and receives information by the radio control module to and from the information terminal detected by the information terminal detection module.

4. An information sending/receiving system according to claim 3, wherein said information transmission/reception unit sends information requested by the information terminal detected by the information terminal detection module.

5. An information sending/receiving system according to claim 3, wherein radio communication is effected via antennas disposed at a plurality of radio relay points.

6. An information sending/receiving system according to claim 5, wherein said antennas are disposed at a plurality of radio relay points which are provided in succession, and
said radio control module sets the antenna, which is located at the endmost radio relay point, in a constantly radio-communicable state, and the antennas, which are located at the radio relay points other than the endmost radio relay point, in a radio-communicable state where necessary.

7. An information sending/receiving system according to claim 6, further comprising a terminal position detection unit which detects the position of the information terminal,
wherein said radio control module sets only that one of the antennas, which is other than the antenna provided at the endmost radio relay point and is close to the information terminal, in a radio-communicable state on the basis of the position of the information terminal detected by the terminal position detection unit.

8. An information sending/receiving system according to claim 3, wherein said radio control module controls radio communication by Bluetooth.

9. An information terminal which acquires information by radio communication, comprising:
a radio control module which executes bidirectional radio communication with an information sending/receiving system;
an information sending/receiving system detection module which detects the information sending/receiving system capable of radio communication by the radio control module;
an information setting unit which sets information to be desired;
an information receiving module which receives information sent from the information sending/receiving system detected by the information sending/receiving system detection module; and
an information output unit which outputs information set by the information setting unit, which corresponds to the information received by the information receiving module.

10. An information terminal according to claim 9, further comprising:
a request unit which requests the information set by the information setting unit from the information sending/receiving system,
wherein said information receiving module receives information from the information sending/receiving system in response to the request by the request unit.

11. An information terminal according to claim 9, further comprising:
a determination unit which determines whether the information received by the information receiving module coincides with the information set by the information setting unit; and
a communication finishing unit which finishes the communication of the radio control module with the information sending/receiving system, when the determination unit has determined that the information received by the information receiving module fails to coincide with the information set by the information setting unit.

12. An information terminal according to claim 9, further comprising:
an input unit which inputs information representing a response to the information output by the information output unit; and
an information transmission unit which transmits the information, which has been by the input unit, to the information sending/receiving system detected by the information sending/receiving system detection module.

13. An information terminal according to claim 9, further comprising:
a position measuring module which measures a current position; and
a position information transmission unit which transmits position information indicative of the current position measured by the position measuring module to the information sending/receiving system detected by the information sending/receiving system detection module.

14. An information terminal according to claim 9, further comprising:
a position measuring module which measures a current position; and
a map output unit which outputs, on a map, the information received by the information receiving module along with information on the current position measured by the position measuring module.
